(19) United States
(12) Patent Application Publication
(10) Pub. No.: US 2005/0068695 A1
(43) Pub. Date: Mar. 31, 2005

(54) Magnetoresistive multilayer film

(76) Inventors: David Djulianto Djayaprawira, Tokyo (JP); Koji Tsunekawa, Tokyo (JP); Motonobu Nagai, Tokyo (JP)

Correspondence Address: HAUPTMAN KANESAKA BERNER PATENT AGENTS, SUITE 300, 1700 DIAGONAL RD, ALEXANDRIA, VA, 22314-2848, US

(21) Appl. No.: 10/948,653

(22) Filed: Sep. 24, 2004

(30) Foreign Application Priority Data
Sep. 26, 2003 (JP) 2003-335454

(51) Int. Cl. G11B 5/33; G11B 5/127

(52) U.S. Cl. 360/324.11

(57) ABSTRACT

This application discloses a magnetoresistive multilayer film having the structure where an antiferromagnetic layer, a pinned-magnetization layer, a non-magnetic spacer layer and a free-magnetization layer are laminated in this order. An opposite-side layer is provided on the side of the antiferromagnetic layer opposite to the pinned-magnetization layer. The opposite-side layer has components of nickel and chromium. Atomic numeral ratio of chromium in the opposite-side layer is preferrably not less than 41% and not more than 70%, more preferrally not less than 43%.

### BACKGROUND OF THE INVENTION

1. Field of the Invention

This invention relates to a magnetoresistive multilayer film utilized for such a magnetic device as giant magnetoresistive (GMR) effect element.

2. Description of the Related Art

The magnetic film technology has been significantly applied to magnetic devices such as magnetic heads and magnetic memories. For example, in magnetic disk drive units for external storages in computers, magnetic heads are mounted for read/write of information. In the field of memory devices, magnetic random access memories (MRAM) utilizing tunnel-type magnetoresistive films for memory elements have been developed. The MRAM is a promising next-generation memory device due to the rapidness of read/write and non-volatility.

In the magnetic devices, magnetoresistive effects are often utilized as means for converting magnetic fields into electric signals. The magnetoresistive effect is the phenomenon that electric resistance is varied according to variation of a magnetic field in a conductor. Especially, such a device as magnetic readout head or MRAM utilizes a giant-magnetoresistive (GMR) film where variation ratio of electric resistance against variation ratio of magnetic field is enormously high. In the field of magnetic recording where further increase of recording density is demanded for enlarging storage capacity, it is necessary to capture slight variation of a magnetic field for reading out stored information. Therefore, the GMR film technology has been utilized in many kinds of magnetic heads, becoming the mainstream.

FIG. 4 is a schematic 3-D view showing the structure of an example of spin-valve type GMR films. The spin-valve type GMR film, hereinafter “SV-GMR film”, has the basic structure where an antiferromagnetic layer 3, a pinned-magnetization layer 4, a nonmagnetic spacing layer (conduction layer) 5 and the free-magnetization layer 6 are laminated in this order. In the SV-GMR film, because the pinned-magnetization layer 4 is adjacent to the anti-ferromagnetic layer 3, magnetic moment in the pinned-magnetization layer 4 is pinned to a direction by the exchange coupling with the antiferromagnetic layer 3. On other hand, because the free-magnetization layer 6 is isolated from the pinned-magnetization layer 4 by the nonmagnetic spacing layer 5, magnetic moment in the free-magnetization layer 6 is capable of free directions.

The giant magnetoresistive effect on the SV-GMR film derives from spin-dependant scattering of electrons on the interface. When a couple of magnetic layers are magnetized to the same direction, free electrons, i.e., conduction electrons, are easily scattered at the interface. Contrarily, when the layers are not magnetized to the same direction, free electrons are hardly scattered at the interface. Therefore, when the magnetization direction in the free-magnetization layer 6 is closer to the one in the pinned-magnetization layer 4 as shown in FIG. 4, the electric resistance would decrease. When the magnetization direction in the free-magnetization layer 6 is closer to the one opposite to the pinned-magnetization layer 4, the electric resistance would increase. The structure performing this GMR effect is called “spin valve”, because the magnetization direction in the free-magnetization layer is spun against the pinned-magnetization layer, which is similar to turning a tap.

Tunnel-type magnetoresistive (TMR) films utilized in MRAM have MR ratios several times as much as the GMR films. “MR ratio” means magnetoresistance ratio, i.e., ratio of electric resistance variation against magnetic field variation. The TMR films are highly expected for next-generation magnetic heads, because of their higher MR ratios. As well as the GMR film, a TMR film has the structure where an antiferromagnetic layer, a pinned-magnetization layer, a nonmagnetic spacer layer and a free-magnetization layer are laminated in this order. The nonmagnetic spacer layer in the TMR film is a very thin film made of insulator, through which a tunnel current flows. Resistance on this tunnel current varies depending on the relative direction of magnetic moment in the free-magnetization layer against the pinned-magnetization layer.

The above-described magnetoresistive multilayer films are manufactured by laminating each thin film for each layer. Each film is deposited by sputtering or another method. In this, what is significant is that the giant-magnetoresistive effect in a GMR film or TMR film derives from spin-dependant scattering of electrons on the interface as described. Accordingly, for obtaining a high MR ratio, what is significant is cleanness of the interface between a couple of layers. In depositing a film for a layer on an underlying layer, if a foreign substance is incorporated in the interface or a contaminant layer is formed in the interface, such a fault as MR ratio decrease might be brought. Accordingly, a chamber in which each film for each layer is deposited should be evacuated at a high-vacuum pressure so that the deposition is carried out in the clean environment. In addition, it is significant to shorten the period after the deposition for a layer until the next deposition for the next layer, and to maintain the clean environment continuously in the period.

Flatness of an interface in a multilayer film is also significant factor in view of enhancing the product performance. Typically, when flatness is worse on the interface of a pinned-magnetization layer and a free-magnetization layer, the interlayer magnetic coupling between the pinned and free magnetization layers would be generated, decreasing the product performance. This point will be described in detail as follows, referring to FIG. 5.

FIG. 5 shows the mechanism of the interlayer coupling generation deriving from the worsened flatness of an interface. It is assumed in FIG. 5 that the magnetization layer 4 is formed as its surface is much roughened. This results in that the nonmagnetic spacer layer 5 and the free-magnetization layer 6 are also formed with the much roughened surfaces. If each surface of each layer 4, 5, 6 is completely flat, theoretically no magnetic poles would appear at the interfaces. Contrarily, magnetic poles would easily appear if the interfaces are roughened. For example, the magnetic lines in the angles of the roughened pinned-magnetization layer 4 generate poles at the ends because they terminate on the slopes of the angles. In the free-magnetization layer 6, the magnetic lines in the roots thereof generate poles at the ends.

When magnetic poles are induced on the interface between the pinned-magnetization layer 4 and the free-magnetization layer 6 as described, the interlayer coupling would take place between them, in spite of isolation by the nonmagnetic spacer layer 5. As a result, magnetic moment in the free-magnetization layer 6 would be captured by the pinned-magnetization layer 4, being not capable of the free rotation. If this happens, for example, in a magnetic readout head, readout signals would be asymmetrical against variation of the external magnetic field (the magnetic field on a storage medium). Otherwise, response of the readout head would be delayed to variation of the external magnetic field. These results might cause kinds of readout errors. It could also happen that a magnetization direction in the free-magnetization layer 6 does not vary relatively against the magnetization direction in the pinned-magnetization layer 4 even when the external magnetic field varies. Therefore, MR ratio tends to decrease when roughness of the interface is worsened.

The problems of the interlayer coupling and the interfacial roughness are discussed in J. Appl. Phys., Vol. 85, No. 8, p 4466-4468. This paper describes roughness is generated from structure of a film being deposited. J. Appl. Phys., Vol. 7, No. 7, p 2993-2998 describes roughness of a film would be promoted when pressure in depositing the film is increased. After all, these papers teach that to decrease pressure in depositing is effective to make interfacial roughness small for reducing the interlayer coupling. However, J. Appl. Phys., Vol. 77, No. 7, p 2993-2998 also points out that intermixing, which means mutual incorporation of materials through an interface, takes place when pressure in depositing a film is decreased.

As another solution for the problem of the interlayer coupling caused by interfacial roughness, it is considered to thicken the nonmagnetic spacer layer. However, when the nonmagnetic spacer layer is thickened in the SV-TMR film, the flow of conductive electrons not contributing to the GMR effect would be promoted, causing the problem of decreasing MR ratio. The flow of those electrons is called “shunt effect”. In the TMR film, on the other hand, because it means that the nonmagnetic spacer layer of insulator is thickened, the whole resistance is increased, resulting in that the optimum tunnel current could be no longer obtained. This would cause the problem of decreasing the product performance.

There is still a further way to reduce roughness of an interface, as shown in the Japanese laid-open No. 2003-86866. In this way, after the film deposition for a layer is carried out, the surface of the deposited film is treated utilizing a plasma before the next film deposition for the next layer. However, a system for this way accompanies the problem of scale enlargement because equipment for the plasma treatment is required. In addition, the problem of decreasing the productivity is also accompanied because the extra step of the plasma treatment is required.

### SUMMARY OF THE INVENTION

This invention is to solve the above-described problems, and presents a magnetoresistive multilayer film having the structure where an antiferromagnetic layer, a pinned-magnetization layer, a non-magnetic spacer layer and a free-magnetization layer are laminated in this order. An opposite-side layer is provided on the side of the antiferromagnetic layer opposite to the pinned-magnetization layer. The opposite-side layer has components of nickel and chromium. Atomic numeral ratio of chromium in the opposite-side layer is preferrably not less than 41% and not more than 70%, more preferrally not less than 43%.

### BRIEF DESCRIPTION OF DRAWINGS

FIG. 1 is a schematic cross-sectional view showing the structure of a magnetoresistive multilayer film as an embodiment of the invention.

FIG. 2 shows the result of an experiment for investigating influence of Cr proportion in the NiCr underlying layer on the interlayer coupling.

FIG. 3 shows the structure of the TMR film prepared in the experiment.

FIG. 4 is a schematic 3-D view showing the structure of an example of SV-GMR films.

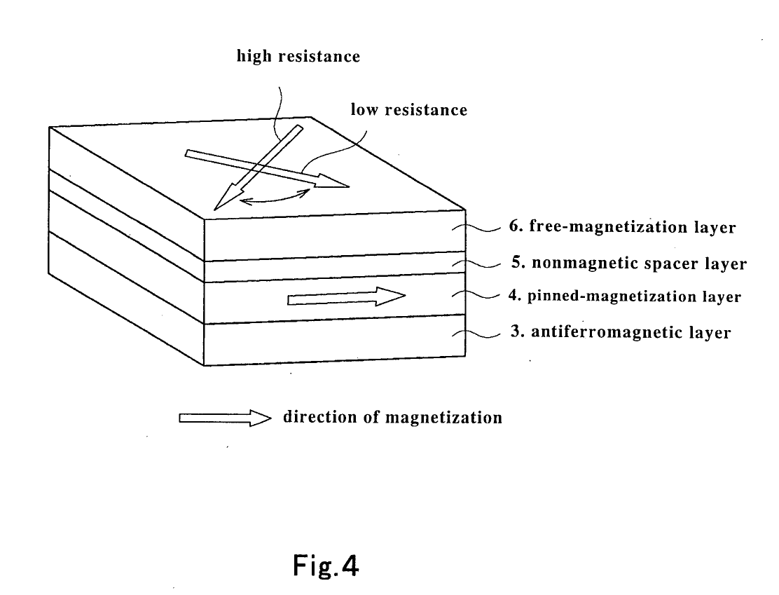

FIG. 5 shows the mechanism of the interlayer coupling deriving from the worsened flatness of an interface.

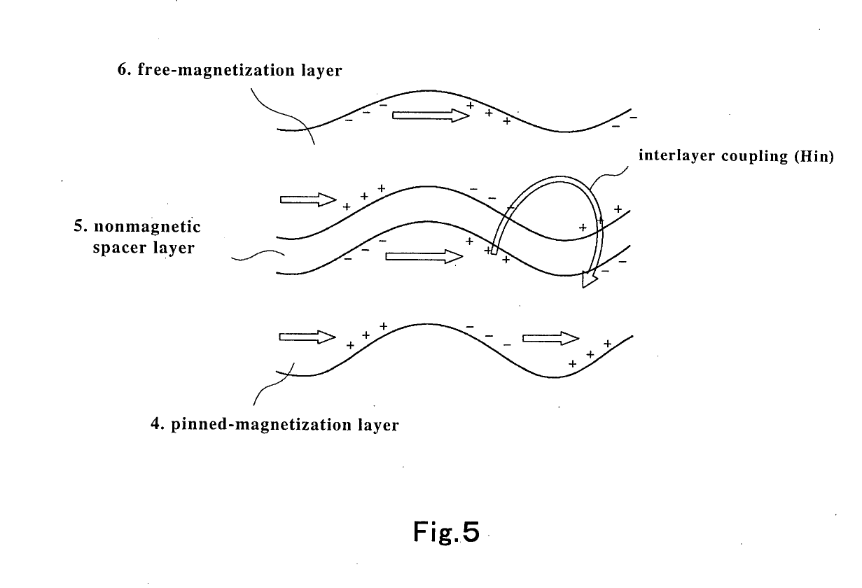

### DETAILED DESCRIPTION OF THE PREFERRED EMBODIMENTS

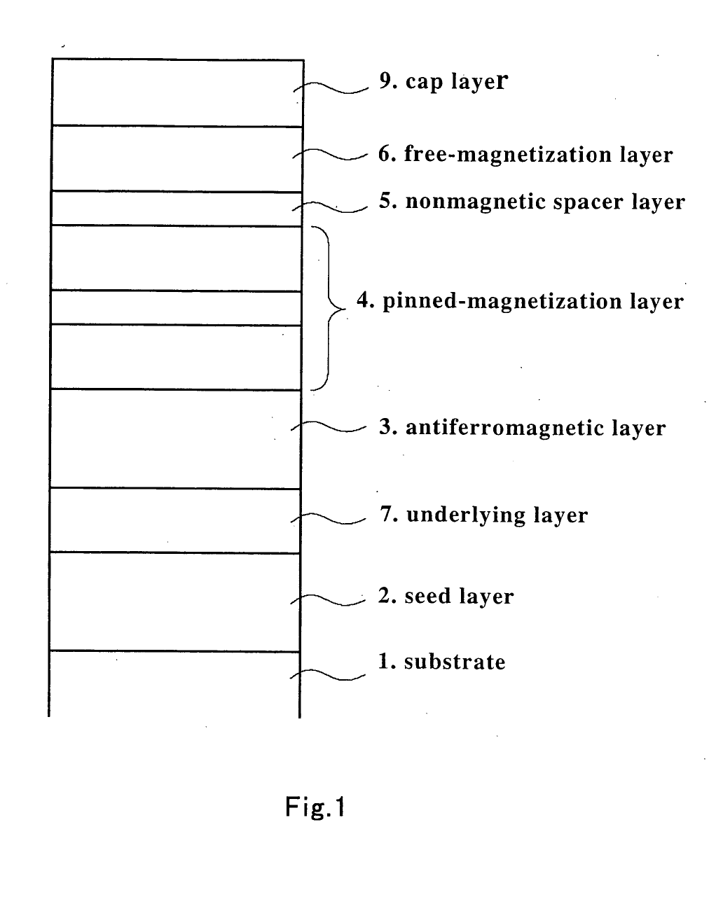

The preferred embodiments of this invention will be described as follows. FIG. 1 is a schematic cross-sectional view showing the structure of a magnetoresistive multilayer film as an embodiment of the invention. The magnetoresistive multilayer film shown in FIG. 1 is used for a magnetic readout head or a MRAM, and works as a SV-GRM film or TMR film. The magnetoresistive multilayer film is provided on a substrate 1 covered with a seed layer 2.

The substrate 1 is made of silicon, glass or AlTiC. In the case of silicon, the surface of the substrate 9 may be thermally oxidized. The seed layer 2 is made of such material as Ta, Cu or Au. The magnetoresistive multilayer film of this embodiment has the structure where an antiferromagnetic layer 3, a pinned-magnetization layer 4, a nonmagnetic spacer layer 5 and a free-magnetization layer 6 are laminated in this order. An opposite-side layer 7 is provided on the side of the antiferromagnetic layer 3 opposite to the pinned-magnetization layer 4. That is, the opposite-side layer 7 is interposed between the seed layer 2 and the antiferromagnetic layer 4. Because the opposite-side layer 7 is located under the antiferromagnetic layer 4 in this embodiment, it is hereinafter called “underlying layer”. The pinned-magnetization layer 5 is the layer where direction of magnetization is pinned by the coupling with the antiferromagnetic layer 3. The free-magnetization layer 6 is the layer that is capable of being magnetized to any direction freely.

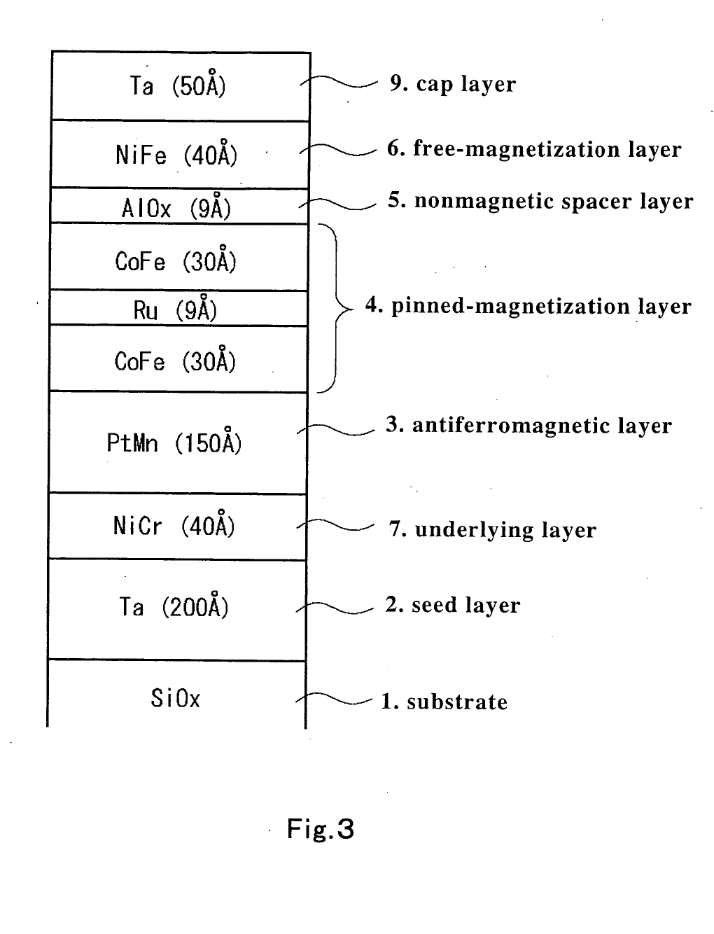

As shown in FIG. 1, the layers 3, 4, 5, 6, 7 are laminated upward in order. This does not always correspond to a situation in practical usage. FIG. 3 and the following description are just on the assumption that a layer formed in a prior step is located lower, and a layer formed in a later step is located upper. Therefore, if the surface of the substrate 1 is directed downward and the layers are laminated thereon, then the opposite-side layer is located above the antiferromagnetic layer 3.

The antiferromagnetic layer 3 is made of such material as PtMn or IrMn. “PtMn” means material components of platinum and manganese, and does not always mean they are alloyed though often alloyed. This is the same as in other expressions using other combinations of the element symbols such as “IrMn”.

Material of the CoFe system is, for example, employed for the pinned-magnetization layer 4. “CoFe system” includes an alloy of cobalt and iron, an alloy of cobalt, iron and other material, and an alloy of cobalt and iron with an additive. The pinned-magnetization layer 4 may be formed of a multilayer film of dissimilar materials such as CoFe/Ru/CoFe. The nonmagnetic spacer layer 5 is made of copper in the case of a GRM film, and of alumina in the case of a TMR film. The free-magnetization layer 6 is made of such material as NiFe. The multilayer where a NiFe film is laminated on a CoFe film may be employed for the free magnetization layer 6. As shown in FIG. 1, a cap layer 9 is provided over the free-magnetization layer 6 for protecting the magnetoresistive multilayer film of this embodiment. The cap layer 9 is made of such material as tantalum.

The underlying layer 7 greatly characterizing the magnetoresistive multilayer film of this embodiment is made of nickel and chromium where atomic numeral ration of chromium is 41% or more. “Atomic numeral ratio” means weight ratio converted by atomic number, i.e., ratio of the numbers of included atoms. Atomic numeral ratio is sometimes abbreviated as “at %”.

The point that the NiCr film where atomic numeral ratio of chromium is 41% or more is employed for the underlying layer 7 is based on the result of a research, which the inventors have done for solving the described problem of the interlayer coupling. Interfacial Roughness causing the problem of the interlayer coupling often results from roughness of another interface located thereunder. When the surface of a film is roughened, the surface of another film deposited thereupon is roughened as well, because the film is deposited as it traces the underlying roughened surface. Therefore, for preventing an interface from being roughened, it is significant to deposit a film located thereunder without roughness.

Searching for how to flatten the interface of the pinned-magnetization layer 4 and the free-magnetization layer 6, which enables reduction of the interlayer coupling between them, the inventors investigated optimum selection and combination of materials for a layer under the pinned-magnetization layer 4. This was on the assumption that those factors of the layer would contribute to flattening the layer itself, thus contributing to flattening the pinned-magnetization layer 4 as well. After the diligent research on this assumption, it has turned out that; when a NiCr film having chromium atomic numeral ratio of 41% or more is deposited for a layer under the antiferromagnetic layer 3, the interlayer coupling between the pinned-magnetization layer 4 and free-magnetization layer 6 is reduced. This point will be described in detail as follows.

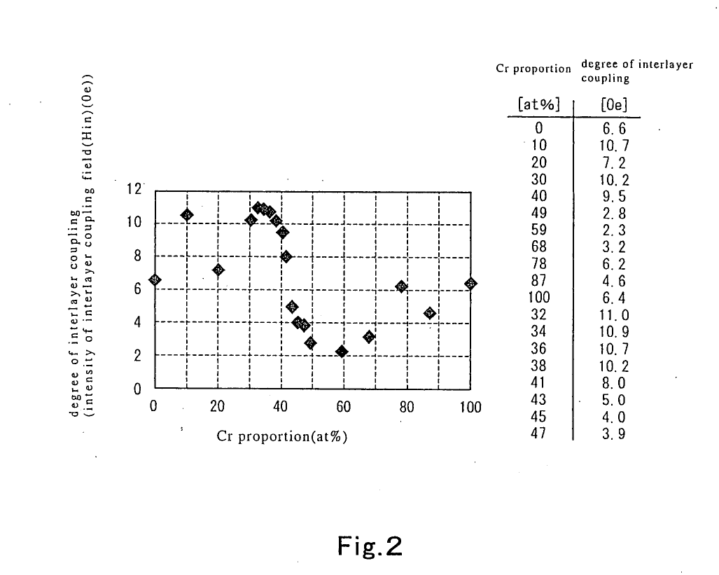

FIG. 2 shows the result of an experiment for investigating how Cr proportion in the NiCr underlying layer influences the interlayer coupling. In FIG. 2, the abscissa axis is Cr proportion, and the ordinate axis is degree of the interlayer coupling, i.e., intensity of the interlayer-coupling magnetic field (Hin) (Oe), between the pinned-magnetization layer 4 and the free-magnetization layer 6. Actual data are shown at the right side to the graph in FIG. 2. In this experiment, a TMR film comprising the NiCr film for the underlying layer 7 was prepared. Then, degree of the interlayer coupling between the pinned-magnetization layer 4 and the free-magnetization layer 6 was measured.

FIG. 3 shows the structure of the TMR film prepared in the experiment. The figures in the parentheses in FIG. 3 mean thickness of the films. As shown in FIG. 3, a Ta film for the seed layer 2 was deposited at 200 angstrom thickness on thermally oxidized surface of a silicon-made substrate 1. On the Ta film, a NiCr film for the underlying layer 7 was deposited at 40 angstrom thickness. On the NiCr film, a PtMn film (Pt50Mn50at %) for the antiferromagnetic layer 3 was deposited at 150 angstrom thickness. On the PtMn film, for the pinned-magnetization layer 4 a couple of CoFe films (Co90Fe10 at %) are deposited at 30 angstrom thickness respectively, interposing a Ru film of 30 angstrom thickness. On the CoFe film, an alumina film for the nonmagnetic spacer layer 5 was deposited at 9 angstrom thickness. On the alumina film, a NiFe film (Ni83Fe17 at %) for the free-magnetization layer 6 was deposited at 40 angstrom thickness. On the NiFe film, a Ta film for the cap layer 9 was deposited at 50 angstrom thickness. Each film was deposited by DC magnetron sputtering. Several TMR films having the above-described structure were prepared. Cr proportion in the underlying layers 7 of the TMR films was varied. Then, degree of the interlayer coupling between the pinned-magnetization layer 4 and the free-magnetization layer 6 in each TMR film was measured.

As shown in FIG. 2, in the range where Cr proportion was up to about 40 at %, the interlayer coupling (Hin) exhibited a high value of around 10 Oe. However, where Cr proportion exceeded 40 at % and reached 41 at % or more, it dropped down to 80 Oe or below. In the range where Cr proportion exceeded 68 at % up to 100 at %, the interlayer coupling (Hin) remained at a low value around 6 to 6.4 Oe, though it turned to rising. From the results shown in FIG. 2, it is understood that Cr proportion ranging from 43 at % to 70 at % is much preferable because the interlayer coupling (Hin) is the low value of 50 Oe or below.

Inclusion of nickel in the underlying layer 7 has the purpose of reducing the grain size of the film. If the film contains no or very little nickel, that is, Cr proportion is too high, it brings the problem of enlarging the grain size. When nickel having the grain structure of face-centered cubic (fcc) is added to chromium having the grain structure of body-centered cubic center (bcc), the grain size is made smaller. Thus, the film shifts to an amorphous state in a range, e.g., Cr proportion of 60 at % or less. A film of fine grains or an amorphous state is preferable in view of improving magnetic properties such as MR ratio because of much better flatness of the surface. A film of low Ni proportion at high Cr proportion would have a grain structure where bcc is dominant, resulting in that the grain size tends to be enlarged. Therefore, Cr proportion is preferably 70 at % or less.

The described structure of FIG. 3, which is the embodiment as the TMR film, is modified to the embodiment as a SV-GMR film. In the SV-GMR film, concretely, the nonmagnetic spacer layer 5 is made of cupper and 2.0 nm in thickness. The rest of the structure may be the same. Such a SV-GMR film was prepared, and MR ratio was measured as well. This SV-GMR film also exhibited a prominent improvement in reducing the interlayer coupling between the pinned-magnetization layer 4 and the free-magnetization layer 6 when Cr proportion in the underlying layer 7 was 41 at % or more. Specifically, though the interlayer coupling was 2.1 Oe at Cr proportion of 40at %, it decreased to 1.2 Oe at Cr proportion of 41 at %. Though MR ration was 15.1% at Cr proportion of 40 at %, it increased to 16.3% at Cr proportion of 41 at %. The prominent improvement of MR ratio was confirmed as well.

As described, the interlayer coupling between the pinned-magnetization layer 4 and the free-magnetization layer 6 are reduced in the magnetoresistive multilayer film of the embodiment. Therefore, there is the less probability that magnetic moment in the free-magnetization layer 6 is captured and restricted by magnetic moment in the pinned-magnetization layer 4. This brings the merit of reducing readout errors and response delays in a magnetic readout head, and the merit of reducing write-in errors and readout errors in a MRAM. These merits are much prominent at Cr proportion ranging from 43 at % to 70 at %. Cr proportion of 70 at % or less brings the merit of reducing the grain size as well, because a sufficient quantity of nickel can be contained.

The concept in the magnetoresistive multilayer film of the embodiment is not to add such an extra step as plasma treatment, but to reduce the interlayer coupling by optimizing Cr proportion in the underlying layer 7. Therefore, the magnetoresistive multilayer film of the embodiment is free from such problems as decrease of the productivity and increase of the cost for a manufacturing system. Still, the invention does not exclude addition of such a step as plasma treatment. Any extra step, treatment or process may be added for the described structure where Cr proportion is optimized.

Manufacture of the magnetoresistive multilayer film of the embodiment will be described next. As described, each film for each layer is deposited by sputtering. Therefore, a manufacturing system comprises a multiplicity of deposition chambers in which each film is deposited by sputtering respectively. There are roughly two types in layout of the deposition chambers, i.e., cluster-tool type and in-line type. In the case of the cluster-tool type, a transfer chamber comprising a transfer robot therein is provided in the center, and the deposition chambers are air-tightly connected to the periphery of the transfer chamber. A substrate is transferred to the deposition chambers in order by the transfer robot. In the case of the in-line type, a substrate is loaded on a carrier capable of moving linearly. A multiplicity of deposition chambers are provided along the transfer line, and connected air-tightly to each other. In any type, each film for each layer is deposited continuously under vacuum without exposing the substrate to the atmosphere.

The magnetoresistive multilayer film is manufactured by sputter-deposition of films for the underlying layer 7, the antiferromagnetic layer 3, the pinned-magnetization layer 4, the nonmagnetic spacer layer 5, the free-magnetization layer 6 and the cap layer 9 in order on the substrate 9 coated with the seed layer 2. In the manufacturing system, multi-cathode configuration may be practical in the chamber for forming the underlying layer 7. Concretely, a cathode comprising a Ni-made target and a cathode comprising a Cr-made target are provided in the chamber. As power applied to each cathode is controlled independently, the NiCr film having Cr proportion in the described range is deposited.

Though the underlying layer 7 in the described magnetoresistive multilayer film was made of nickel and chromium only, it may include other material such as iron, tantalum orniobium. Cr proportion may be in the described range against the whole quantity including such other material. Though the GMR film and the TMR film were adopted in the above description, the magnetoresistive multilayer film of this invention is limited neither to the described SV-GMR film nor to the described GMR film. This invention can be applied to any other multilayer film performing the magnetoresistive effect.

1. A magnetoresistive multilayer film, comprising
an antiferromagnetic layer;
a pinned-magnetization layer where direction of magnetization is pinned by coupling with the antiferromagnetic layer;
a nonmagnetic spacer layer; and
a free-magnetization layer where direction of magnetization is free;
having a structure where the antiferromagnetic layer, the pinned-magnetization layer, the nonmagnetic spacer layer and the free-magnetization layer are laminated in this order;
further comprising an opposite-side layer on the side of the antiferromagnetic layer opposite to the pinned-magnetization layer;
the opposite-side layer having components of nickel and chromium;
atomic numeral ratio of chromium in the opposite-side layer being not less than 41%.

2. A magnetoresistive multilayer film as claimed in claim 1,
atomic numeral ratio of chromium in the opposite-side layer being not more than 70%.

3. A magnetoresistive multilayer film, comprising
an antiferromagnetic layer;
a pinned-magnetization layer where direction of magnetization is pinned by coupling with the antiferromagnetic layer;
a nonmagnetic spacer layer; and
a free-magnetization layer where direction of magnetization is free;
having a structure where the antiferromagnetic layer, the pinned-magnetization layer, the non-magnetic spacer layer and the free-magnetization layer are laminated in this order;
further comprising an opposite-side layer on the side of the antiferromagnetic layer opposite to the pinned-magnetization layer;
the opposite-side layer having components of nickel and chromium;
atomic numeral ratio of chromium in the opposite-side layer being not less than 43% and not more than 70%.

4. A spin-valve type giant-magnetoresistive multilayer film, comprising
an antiferromagnetic layer;
a pinned-magnetization layer where direction of magnetization is pinned by coupling with the antiferromagnetic layer;
a nonmagnetic spacer layer; and
a free-magnetization layer where direction of magnetization is free;
having a structure where the antiferromagnetic layer, the pinned-magnetization layer, the non-magnetic spacer layer and the free-magnetization layer are laminated in this order;
further comprising an opposite-side layer on the side of the antiferromagnetic layer opposite to the pinned-magnetization layer;
the opposite-side layer having components of nickel and chromium;
atomic numeral ratio of chromium in the opposite-side layer being not less than 41%;
the non-magnetic spacer layer being made of conductor.

5. A spin-valve type giant-magnetoresistive multilayer film as claimed in claim 4,
atomic numeral ratio of chromium in the opposite-side layer being not more than 70%.

6. A tunnel type giant-magnetoresistive multilayer film, comprising
an antiferromagnetic layer;
a pinned-magnetization layer where direction of magnetization is pinned by coupling with the antiferromagnetic layer;
a nonmagnetic spacer layer; and
a free-magnetization layer where direction of magnetization is free;
having a structure where the antiferromagnetic layer, the pinned-magnetization layer, the nonmagnetic spacer layer and the free-magnetization layer are laminated in this order;
further comprising an opposite-side layer on the side of the antiferromagnetic layer opposite to the pinned-magnetization layer;
the opposite-side layer having components of nickel and chromium;
atomic numeral ratio of chromium in the opposite-side layer being not less than 41%;
the non-magnetic spacer layer being made of insulator.

7. A tunnel type giant-magnetoresistive multilayer film as claimed in claim 6,
atomic numeral ratio of chromium in the opposite-side layer being not more than 70%.

8. A tunnel type giant-magnetoresistive multilayer film, comprising
an antiferromagnetic layer;
a pinned-magnetization layer where direction of magnetization is pinned by coupling with the antiferromagnetic layer;
a nonmagnetic spacer layer; and
a free-magnetization layer where direction of magnetization is free;
having a structure where the antiferromagnetic layer, the pinned-magnetization layer, the non-magnetic spacer layer and the free-magnetization layer are laminated in this order;
further comprising an opposite-side layer on the side of the antiferromagnetic layer opposite to the pinned-magnetization layer;
the opposite-side layer having components of nickel and chromium;
atomic numeral ratio of chromium in the opposite-side layer being not less than 43% and not more than 70%;
the nonmagnetic spacer layer being made of insulator.
